(19) United States
(12) Patent Application Publication
(10) Pub. No.: US 2025/0249478 A1
(43) Pub. Date: Aug. 7, 2025

(54) COATING APPARATUS AND COATING METHOD

(71) Applicant: CHUGAI RO CO., LTD., Osaka-shi, Osaka (JP)

(72) Inventor: Masaki YOKOYAMA, Osaka-shi, Osaka (JP)

(21) Appl. No.: 18/854,519

(22) PCT Filed: Jul. 21, 2022
(86) PCT No.: PCT/JP2022/028319

§ 371 Date: Oct. 4, 2024

(30) Foreign Application Priority Data
Apr. 25, 2022 (JP) 2022-071452

(51) Int. Cl. B05D 1/26; B05C 5/02

(52) U.S. Cl. CPC B05D 1/26; B05C 5/0262

(57) ABSTRACT

A coating apparatus in which a coating solution p supplied to a coating solution housing 32 in a coating nozzle 30 is discharged onto a coating object W through a slit-shaped outlet 33 at a distal end of the coating nozzle and in which the coating nozzle and the coating object are moved relative to each other in a coating direction in which the coating solution is applied onto the coating object to apply the coating solution onto a surface of the coating object, includes: a coating width adjuster 50 that adjusts a width of application of the coating solution in the coating solution housing onto the coating object through the slit-shaped outlet; and an intersection direction mover 40 that moves the coating nozzle and the coating object relative to each other in a direction intersecting the coating direction.

### TECHNICAL FIELD

The present teaching relates to a coating apparatus in which a coating solution supplied to a coating solution housing in a coating nozzle is discharged onto a coating object through a slit-shaped outlet at a distal end of the coating nozzle and in which the coating nozzle and the coating object are moved relative to each other in a coating direction in which the coating solution is applied onto the coating object to apply the coating solution onto the surface of the coating object and relates to a coating method using such a coating apparatus. In particular, the coating apparatus as described above has a feature in easing application of the coating solution onto the surface of the coating object in various patterns by changing a coating width and a coating position in application of the coating solution onto the coating object.

### BACKGROUND ART

Conventional manufacturing of semiconductor devices, liquid crystal panels and the like includes the process of applying substances such as a chemical solution and a paint onto glass or films. As an application pattern of application of a substance such as a chemical solution or a paint, the substance is conventionally applied in a rectangular shape or a circular shape. However, recent diversification of products requires various patterns of shape in application.

In view of this, as proposed in Patent Documents 1 and 2, conventional techniques use a coating apparatus in which a coating nozzle including a slit-shaped outlet is used to discharge a coating solution housed in a coating solution housing in the coating nozzle to a coating object from the slit-shaped outlet at a distal end of the coating nozzle, and the coating nozzle and the coating object are moved relative to each other in a coating direction in which the coating solution is applied onto the coating object to thereby apply the coating solution onto a surface of the coating object.

In the apparatuses proposed in Patent Documents 1 and 2, however, since the coating solution is applied onto the surface of the coating object from the entire slit-shaped outlet with the coating nozzle and the coating object moved relative to each other in the coating direction in which the coating solution is applied onto the coating object, the coating solution can be applied onto the surface of the coating object in a rectangular pattern, but cannot be applied onto the surface of the coating object in various patterns while changing a coating width and a coating position in application of the coating solution onto the coating object.

Patent Document 3 proposes an apparatus in which a columnar coating solution supplier whose outer peripheral surface includes a guide recess with a predetermined pattern shape for guiding a coating solution in a coating solution housing to a slit-shaped outlet is rotatably located above the slit-shaped outlet and is rotated above the slit-shaped outlet so that the coating solution in the coating solution housing is guided to the slit-shaped outlet through the guide recess to be applied onto the surface of a coating object.

In the apparatus of Patent Document 3, the coating solution supplier with an oval guide recess is rotated above the slit-shaped outlet to apply the coating solution onto the surface of the coating object in a circular shape, and the coating solution supplier with a guide recess of another shape is rotated above the slit-shaped outlet to apply the coating solution onto the surface of the coating object in a different shape.

In Patent Document 3, however, to apply the coating solution onto the surface of the coating object in different shapes, a larger number of coating solution suppliers with guide recesses of various shapes need to be prepared so that the coating solution supplier with a guide recess of an intended shape needs to be used at each time. This increases costs and makes work of exchanging coating solution suppliers in the coating solution housing significantly troublesome, and thus, it is impossible to apply the coating solution onto the surface of the coating object in various patterns while changing a coating width and a coating position in application of the coating solution onto the coating object.

Patent Document 4 proposes an apparatus in which a cylindrical nozzle body includes a discharge slit elongated along an axial direction, a cylindrical adjustment inner cylinder having a trapezoidal notch hole is rotatably inserted in the nozzle body, and the notch hole of the adjustment inner cylinder is positioned with respect to the discharge slit in the nozzle body so that a width of a coating solution applied onto the surface of a coating object is adjusted.

In a manner similar to Patent Documents 1 through 3, Patent Document 4 also fails to apply the coating solution in various patterns while changing a coating width and a coating position in application of the coating solution onto the coating object.

Patent Document 5 proposes an apparatus in which a nozzle portion including an outlet at the lower end thereof is moved in a direction intersecting a movement direction of a coating object to apply a coating solution onto the surface of the coating object. Patent Document 6 proposes an apparatus in which a slit nozzle movable in the longitudinal direction is set at one side, a coating solution is applied from the slit nozzle onto this side of the surface of a coating object, then the slit nozzle is moved in the longitudinal direction and set on the other side, and the coating solution is applied from the slit nozzle onto this side of the surface of the coating object so that the coating solution is thereby applied onto the entire surface of the coating object.

However, in a manner similar to Patent Documents 1 through 4, the apparatuses of Patent Documents 5 and 6 also fail to apply the coating solution onto the surface of the coating object in various patterns while changing a coating width and a coating position in application of the coating solution onto the coating object.

### CITATION LIST

### Patent Document

Patent Document 1: Japanese Patent No. 6326315
Patent Document 2: Japanese Patent No. 4260199
Patent Document 3: Japanese Patent No. 6847560
Patent Document 4: Japanese Patent Application Publication No. H10-192762
Patent Document 5: Japanese Patent Application Publication No. 2003-224066
Patent Document 6: Japanese Patent Application Publication No. 2004-63620

### SUMMARY OF INVENTION

### Technical Problem

It is therefore an object of the present teaching to solve the problems described above in a coating apparatus in which a coating solution housed in a coating solution housing in a coating nozzle is discharged onto a coating object from a slit-shaped outlet at a distal end of the coating nozzle, and the coating nozzle and the coating object are moved relative to each other in a coating direction in which the coating solution is applied onto the coating object to apply the coating solution onto a surface of the coating object.

That is, an object of the present teaching is to simplify application of the coating solution onto the surface of the coating object in various patterns while changing a coating width and a coating position in application of the coating solution onto the coating object in the coating apparatus as described above.

### Solution to Problem

To solve the problems described above, a coating apparatus according to the present teaching is a coating apparatus in which a coating solution supplied to a coating solution housing in a coating nozzle is discharged onto a coating object through a slit-shaped outlet at a distal end of the coating nozzle and in which the coating nozzle and the coating object are moved relative to each other in a coating direction in which the coating solution is applied onto the coating object to apply the coating solution onto a surface of the coating object, and the coating apparatus includes: a coating width adjuster that adjusts a width of application of the coating solution from the coating solution housing onto the coating object through the slit-shaped outlet; and an intersection direction mover that moves the coating nozzle and the coating object relative to each other in a direction intersecting the coating direction.

In the coating apparatus according to the present teaching, in applying the coating solution onto the surface of the coating object by discharging the coating solution to the coating object through the slit-shaped outlet at the distal end of the coating nozzle and moving the coating nozzle and the coating object relative to each other in the coating direction in which the coating solution is applied onto the coating object, the coating width adjuster adjusts the width of application of the coating solution from the coating solution housing onto the coating object through the slit-shaped outlet, and the intersection direction mover moves the coating nozzle and the coating object relative to each other in the coating direction. Thus, the width of the coating solution applied onto the surface of the coating object and the position on the coating object onto which the coating solution is applied can be easily changed, and the coating solution can be applied in various patterns.

In the coating apparatus according to the present teaching, the coating width adjuster is a columnar coating solution supplier whose outer peripheral surface includes a guide recess with a predetermined pattern shape for guiding the coating solution in the coating solution housing to the slit-shaped outlet, and the coating solution supplier is rotatably located above the slit-shaped outlet and is rotated above the slit-shaped outlet so that the coating solution in the coating solution housing is thereby guided to the slit-shaped outlet through the guide recess, or the slit width adjusting member that adjusts the slit width in the slit-shaped outlet is provided to adjust the width of the coating solution guided to the surface of the coating object through the slit-shaped outlet.

A coating method according to the present teaching includes application of a coating solution onto a surface of a coating object by using the coating apparatus described above.

### Advantageous Effects of Invention

In the coating apparatus according to the present teaching, the coating solution is discharged onto the coating object through the slit-shaped outlet at the distal end of the coating nozzle, the coating nozzle and the coating object are moved relative to each other in the coating direction in which the coating solution is applied onto the coating object, the coating width adjuster adjusts the width of application of the coating solution in the coating solution housing onto the coating object through the slit-shaped outlet, and the intersection direction mover moves the coating nozzle and the coating object relative to each other in the direction intersecting the coating direction.

As a result, the coating apparatus according to the present teaching can easily apply the coating solution onto the surface of the coating object in various patterns while changing a coating width and a coating position of application of the coating solution onto the coating object.

### BRIEF DESCRIPTION OF DRAWINGS

FIGS. 1A and 1B illustrate a state where a coating solution is applied from a coating nozzle onto a surface of a coating object placed on a fixed table in a coating apparatus according to an embodiment of the present teaching, FIG. 1A is a partial schematic plan view, and FIG. 1B is a schematic front view.

FIGS. 2A and 2B illustrate a state where the outer peripheral surface of a coating solution supplier rotatably located in a coating solution housing in the coating nozzle for supplying the coating solution includes a guide recess having a substantially triangular planar shape in the coating apparatus according to the embodiment. FIG. 2A is a schematic front view of the coating solution supplier including the guide recess, and FIG. 2B is a development view of the outer peripheral surface of the coating solution supplier including the guide recess.

FIG. 3 illustrates a state where the coating solution supplier is rotatably located above a slit-shaped outlet in the coating solution housing in the coating nozzle in the coating apparatus according to the embodiment. FIG. 3A is a schematic cross-sectional illustration of the coating nozzle in the longitudinal direction, and FIG. 3B is a schematic cross-sectional illustration of the coating nozzle in a direction intersecting the longitudinal direction.

FIGS. 4A and 4B are the schematic cross-sectional illustrations illustrating a state where the coating solution supplier in the coating solution housing is rotated above the slit-shaped outlet to change the width of the guide recess communicating with the slit-shaped outlet so that the width of the coating solution applied onto the surface of the coating object is changed in the coating apparatus according to the embodiment.

FIG. 5 is a schematic plan view illustrating a state where the coating nozzle is moved in a coating direction in which the coating solution is applied onto the coating object and moved in a direction intersecting the coating direction, and the width of the coating solution applied onto the surface of the coating object is adjusted so that the coating solution is applied onto the surface of the coating object in various shapes in plan view in the coating apparatus according to the embodiment.

FIGS. 6A and 6B illustrate a variation example in which the coating apparatus according to the embodiment includes a pair of slit width adjusting members for adjusting an opening/closing state of the slit-shaped outlet as a coating width adjuster, and are schematic cross-sectional illustrations of the coating nozzle in the longitudinal direction illustrating a state where the width of the coating solution applied onto the surface of the coating object is adjusted by the slit width adjusting members.

### DESCRIPTION OF EMBODIMENT

A coating apparatus and a coating method according to an embodiment of the present teaching will now be specifically described with reference to the accompanying drawings. The coating apparatus and the coating method according to the present teaching are not limited to examples described in the following embodiment, and can be carried out with an appropriate change without departing from the gist of the invention.

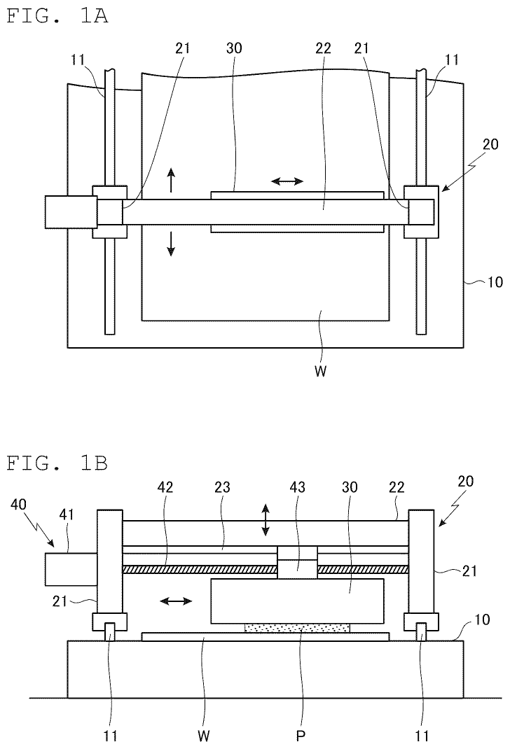

In the coating apparatus according to this embodiment, as illustrated in FIGS. 1A and 1B, a coating object W is placed on a fixed table 10, traveling rails 11 each extending along the longitudinal direction of the coating object W that is a coating direction in which a coating solution p is applied onto the coating object W are constructed at both sides of the coating object W in the width direction, a traveling carriage 20 having a gate shape formed by bridging a beam 22 across a pair of struts 21 is set on the traveling rails 11, a coating nozzle 30 is attached to the traveling carriage 20, and the traveling carriage 20 is caused to travel along the traveling rails 11 in the longitudinal direction of the coating object W.

In the coating apparatus according to this embodiment, the coating nozzle 30 is movably held by a guide rail 23 located under the beam 22 in the traveling carriage 20 and is moved by an intersection direction mover 40 in the width direction of the coating object W intersecting the coating direction. The beam 22 is allowed to move upward and downward in the top-bottom direction by an elevation mechanism (not shown) located on the struts 21.

In the coating apparatus according to this embodiment, as the intersection direction mover 40, the traveling carriage 20 includes a motor 41 and a long external thread 42, and the motor 41 rotates the external thread 42 so that the coating nozzle 30 is moved in the width direction of the coating object W intersecting the coating direction through a screw block 43 included in the coating nozzle 30.

In the coating nozzle 30, an opening/closing valve 35 in a coating solution supplying pipe 34 of a coating solution supplying device (not shown) is opened to supply the coating solution p to a coating solution housing 32, and the coating solution p supplied to the coating solution housing 32 is applied onto the coating object W through a slit-shaped outlet 33 at a distal end of the coating nozzle 30.

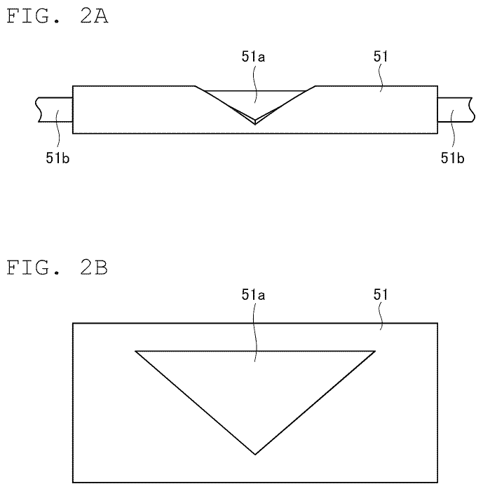

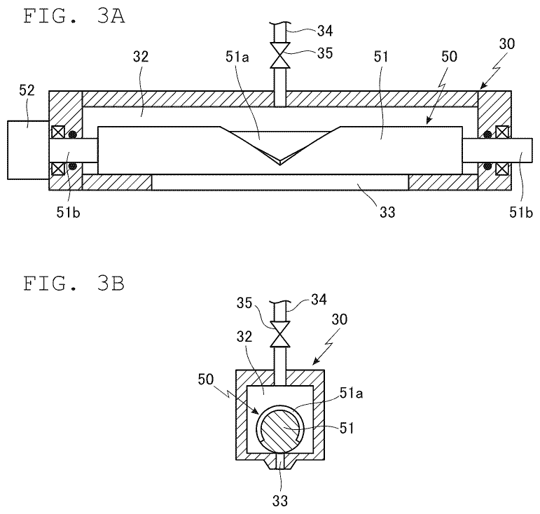

In the coating apparatus according to this embodiment, as a coating width adjuster 50 that causes the coating solution p supplied to the coating solution housing 32 in the coating nozzle 30 to be discharged onto the coating object W through the slit-shaped outlet 33 and adjusts the width of application onto the surface of the coating object W, a columnar coating solution supplier 51 whose outer peripheral surface includes a guide recess 51a with a substantially triangular planar shape as illustrated in FIGS. 2A and 2B is used, the coating solution supplier 51 is rotatably placed above the slit-shaped outlet 33 in the coating solution housing 32 as illustrated in FIGS. 3A and 3B, and a rotation shaft 51b in the coating solution supplier 51 is rotated by a rotator 52. In this embodiment, the outer peripheral surface of the columnar coating solution supplier 51 includes the guide recess 51a with the substantially triangular planar shape. However, the shape of the guide recess 51a is not particularly limited, and may be various shapes such as an oval or a trapezoid.

The coating nozzle 30 is lowered by the elevation device (not shown) together with the beam 22, and the lowering of the coating nozzle 30 is stopped when the distance between the slit-shaped outlet 33 and the surface of the coating object W reaches a predetermined distance. Then, the opening/closing valve 35 in the coating solution supplying pipe 34 is opened so that the coating solution p is supplied to the coating solution housing 32.

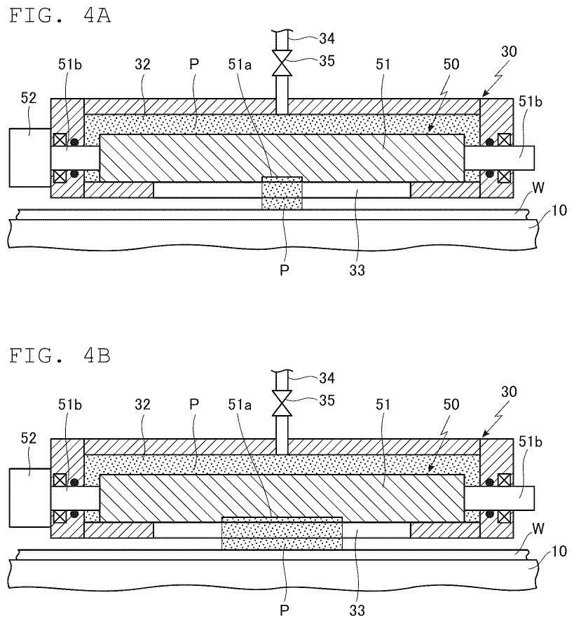

In this state, the rotator 52 rotates the coating solution supplier 51 above the slit-shaped outlet 33, and the guide recess 51a on the outer peripheral surface of the coating solution supplier 51 is guided to the position of the slit-shaped outlet 33. Then, the coating solution p supplied to the coating solution housing 32 is supplied onto the surface of the coating object W through the slit-shaped outlet 33 communicating with the guide recess 51a. Thereafter, as illustrated in FIGS. 4A and 4B, the width of the guide recess 51a communicating with the slit-shaped outlet 33 is adjusted by rotating the coating solution supplier 51 so that the coating solution p with a width corresponding to the width of the guide recess 51a communicating with the slit-shaped outlet 33 is applied onto the surface of the coating object W from the guide recess 51a through the slit-shaped outlet 33.

In a case where application of the coating solution p onto the surface of the coating object W is finished, the opening/closing valve 35 in the coating solution supplying pipe 34 is closed, and the coating nozzle 30 is lifted by the elevation device (not shown) together with the beam 22 to return to the original position.

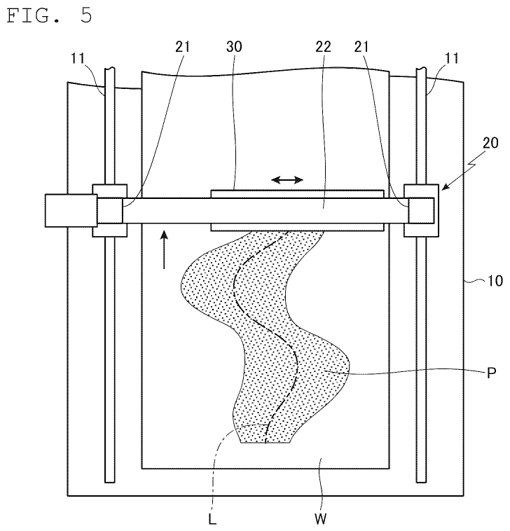

Subsequently, in the coating apparatus according to this embodiment, as illustrated in FIG. 5, in applying the coating solution p onto the surface of the coating object W in various planar shapes, the traveling carriage 20 is caused to travel along the traveling rails 11 in the longitudinal direction of the coating object W to move the coating nozzle 30 in the coating direction in which the coating solution p is applied onto the coating object W as described above, and the long external thread 42 is rotated by the motor 41 of the traveling carriage 20 to move the coating nozzle 30 in a direction intersecting the coating direction so that the position on the surface of the coating object W at which the coating solution p is applied from the coating nozzle 30 is shifted in a direction intersecting the coating direction, and in addition, the coating solution supplier 51 is rotated in the coating solution housing 32 to adjust the width with which the guide recess 51a on the outer peripheral surface of the coating solution supplier 51 communicates with the slit-shaped outlet 33 so that the width of application of the coating solution p onto the surface of the coating object W is thereby changed.

In FIG. 5, since the guide recess Sla on the outer peripheral surface of the coating solution supplier 51 has a symmetric triangular shape, the applied coating solution p has the same width on the left and right of a trajectory L at the center of the guide recess 51a in the width direction.

In the apparatus of this embodiment, in applying the coating solution p onto the surface of the coating object W in a desired pattern, while the width of the coating solution p supplied through the slit-shaped outlet 33 is changed to a desired coating width by rotating the coating solution supplier 51, the coating nozzle 30 is moved in the coating direction and is moved by a controller (not shown) in a direction intersecting the coating direction such that the center in the coating width coincides with the center of the slit-shaped outlet 33. Then, application can be performed in various patterns, unlike conventional techniques.

In a case where the guide recess 51a on the outer peripheral surface of the coating solution supplier 51 is not symmetric, the widths of the coating solution p applied on the left and right of the trajectory L at the center of the guide recess 51a are different.

In the coating apparatus according to this embodiment, as the coating width adjuster 50 that adjusts the width of application onto the coating object W through the slit-shaped outlet 33, the columnar coating solution supplier 51 whose outer peripheral surface includes the guide recess 51a having the substantially triangular planar shape as described above is rotatably placed above the slit-shaped outlet 33 in the coating solution housing 32 supplied with the coating solution p. However, the coating width adjuster 50 is not limited to this example.

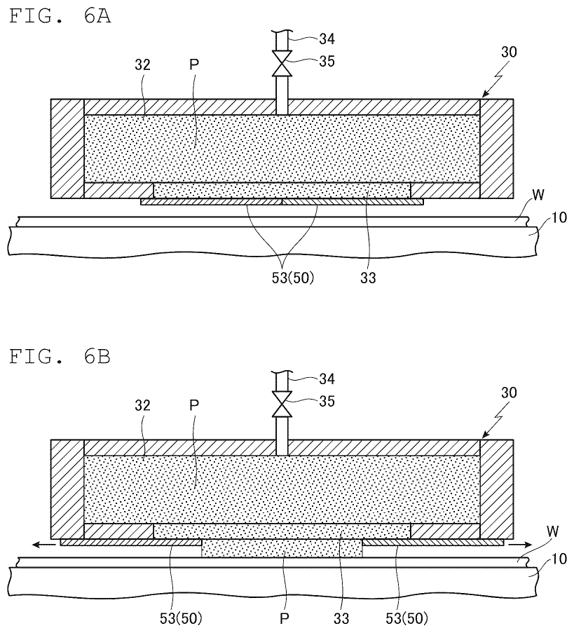

In an alternative example, the coating solution supplier 51 is not provided in the coating solution housing 32, and as illustrated in FIGS. 6A and 6B, as the coating width adjuster 50, a pair of slit width adjusting members 53 that adjusts an opening/closing state of the slit-shaped outlet 33 in the longitudinal direction is provided below the slit-shaped outlet 33, the pair of slit width adjusting members 53 is moved toward or away from each other in the longitudinal direction of the slit-shaped outlet 33 by a slide device (not shown) so that the interval between the pair of slit width adjusting members 53 is adjusted, and the coating solution p in the coating solution housing 32 is applied from the slit-shaped outlet 33 onto the coating object W through the space between the pair of slit width adjusting members 53.

In the coating apparatus according to this embodiment, in moving the coating nozzle 30 and the coating object W relative to each other in the coating direction in which the coating solution p is applied onto the coating object W, the coating nozzle 30 is set in the traveling carriage 20, and the traveling carriage 20 is caused to travel along the traveling rails 11 in the coating direction that is the longitudinal direction of the coating object W. However, the method of moving the coating nozzle 30 and the coating object W relative to each other in the coating direction is not limited to this example.

In an alternative example, although not shown, the coating nozzle 30 is placed immovably in the coating direction, whereas a moving stage (not shown) that moves in the coating direction is placed on the fixed table 10, and the coating object W is placed on the moving stage so that the moving stage can thereby move the coating object W in the coating direction.

In the coating apparatus according to this embodiment, in moving the coating nozzle 30 and the coating object W relative to each other in the direction intersecting the coating direction, the coating nozzle 30 is movably held by the guide rail 23 of the traveling carriage 20 so that the coating nozzle 30 is moved by the intersection direction mover 40 in the width direction of the coating object W intersecting the coating direction as described above. However, the method of moving the coating nozzle 30 and the coating object W relative to each other in the direction intersecting the coating direction is not limited to this example.

In an alternative example, although not shown, the coating nozzle 30 is set immovable in the width direction of the coating object W and is attached to the traveling carriage 20, whereas as the intersection direction mover 40, a moving stage (not shown) that moves in the width direction of the coating object W intersecting the coating direction is placed on the fixed table 10, and the coating object W is set on the moving stage so that the moving stage can thereby move the coating object W in the width direction of the coating object W intersecting the coating direction.

### REFERENCE SIGNS LIST

10: fixed table
11: traveling rail
20: traveling carriage
21: strut
22: beam
23: guide rail
30: coating nozzle
32: coating solution housing
33: slit-shaped outlet
34: coating solution supplying pipe
35: opening/closing valve
40: intersection direction mover
41: motor
42: external thread
43: screw block
50: coating width adjuster
51: coating solution supplier
51a: guide recess
51b: rotation shaft
52: rotator
53: slit width adjusting member
L: trajectory
W: coating object
p: coating solution

1. A coating apparatus in which a coating solution supplied to a coating solution housing in a coating nozzle is discharged onto a coating object through a slit-shaped outlet at a distal end of the coating nozzle and in which the coating nozzle and the coating object are moved relative to each other in a coating direction in which the coating solution is applied onto the coating object to apply the coating solution onto a surface of the coating object, the coating apparatus comprising:
a coating width adjuster that adjusts a width of application of the coating solution in the coating solution housing onto the coating object through the slit-shaped outlet; and
an intersection direction mover that moves the coating nozzle and the coating object relative to each other in a direction intersecting the coating direction.

2. The coating apparatus according to claim 1, wherein the coating width adjuster is a columnar coating solution supplier whose outer peripheral surface includes a guide recess with a predetermined pattern shape for guiding the coating solution in the coating solution housing to the slit-shaped outlet, the coating solution supplier being rotatably located above the slit-shaped outlet and being rotated above the slit-shaped outlet so that the coating solution in the coating solution housing is thereby guided to the slit-shaped outlet through the guide recess.

3. The coating apparatus according to claim 1, wherein the coating width adjuster is a slit width adjusting member that adjusts a slit width at the slit-shaped outlet.

4. A coating method, comprising applying a coating solution onto a surface of a coating object by using the coating apparatus according to claim 1.

5. A coating method, comprising applying a coating solution onto a surface of a coating object by using the coating apparatus according to claim 2.

6. A coating method, comprising applying a coating solution onto a surface of a coating object by using the coating apparatus according to claim 3.
